(19) United States
(12) Patent Application Publication
(10) Pub. No.: US 2022/0341812 A1
(43) Pub. Date: Oct. 27, 2022

(54) OPTICAL PULSE TESTER

(71) Applicants: Yokogawa Electric Corporation, Tokyo (JP); Yokogawa Test & Measurement Corporation, Tokyo (JP)

(72) Inventors: Haruyoshi UCHIYAMA, Tokyo (JP); Shoichi AOKI, Tokyo (JP); Katsushi OTA, Tokyo (JP); Akira TAKIKAWA, Tokyo (JP)

(21) Appl. No.: 17/715,580

(22) Filed: Apr. 7, 2022

(30) Foreign Application Priority Data
Apr. 22, 2021 (JP) 2021-072644

(51) Int. Cl. G01M 11/00

(52) U.S. Cl. CPC G01M 11/3127; G01M 11/3145

(57) ABSTRACT

An optical pulse tester is for testing characteristics of an optical fiber on the basis of return light obtained by causing an optical pulse to be incident on the optical fiber. The optical pulse tester includes a plurality of light source elements configured to emit optical pulses of different wavelength bands, a plurality of light receiving elements provided to correspond to the plurality of light source elements, a first spatial optical system in which the optical pulses emitted from the plurality of light source elements are spatially combined by wavelength to be incident on the optical fiber, and a second spatial optical system in which return light from the optical fiber is spatially separated by wavelength to be incident on the plurality of light receiving elements.

### BACKGROUND

### Field of the Invention

The present invention relates to an optical pulse tester.

Priority is claimed on Japanese Patent Application No. 2021-072644, filed on Apr. 22, 2021, the contents of which are incorporated herein by reference.

### Description of Related Art

An optical pulse tester is a device that causes an optical pulse to be incident on an optical fiber to be tested, and tests or measures the characteristics of the optical fiber on the basis of return light obtained from the optical fiber. One type of optical pulse tester is an optical time domain reflectometer (OTDR), which measures the transmission loss of an optical fiber and the distance to a failure point on the basis of Rayleigh scattered light and Fresnel reflected light generated in the optical fiber. Such an OTDR is used, for example, to check the quality of a laying operation at the time of laying an optical fiber, which is a communication medium of an optical communication system, or to search for a failure point of the optical fiber to measure a loss at the time of maintenance after the laying.

When measurement is performed using the OTDR described above, optical pulses of a plurality of wavelengths (for example, 1.31 μm, 1.55 μm) used in communication are usually used. In the OTDR, when measurement is performed for each wavelength, time required for the measurement will be prolonged according to the number of wavelengths. Japanese Unexamined Patent Application Publication No. 2013-24814 discloses an OTDR capable of simultaneously performing measurement (simultaneous multi-wavelength measurement) by causing the optical pulses of a plurality of wavelengths to be incident on an optical fiber.

Incidentally, the OTDR disclosed in Japanese Unexamined Patent Application Publication No. 2013-24814 realizes simultaneous multi-wavelength measurement by causing test light modulated with a random code different for each wavelength length to be incident on an optical fiber, and performing a correlation operation between a light receiving signal of return light obtained from the optical fiber and the random code described above. However, there is a problem that a spurious component occurs when such a correlation operation is performed, and it may cause a decrease in measurement accuracy.

### SUMMARY

An optical pulse tester may be for testing characteristics of an optical fiber on the basis of return light obtained by causing an optical pulse to be incident on the optical fiber. The optical pulse tester may include a plurality of light source elements configured to emit optical pulses of different wavelength bands, a plurality of light receiving elements provided to correspond to the plurality of light source elements, a first spatial optical system in which the optical pulses emitted from the plurality of light source elements are spatially combined by wavelength to be incident on the optical fiber, and a second spatial optical system in which the return light from the optical fiber is spatially separated by wavelength to be incident on the plurality of light receiving elements.

Further features and aspects of the present disclosure will become apparent from the following detailed description of exemplary embodiments with reference to the attached drawings.

### BRIEF DESCRIPTION OF THE DRAWINGS

FIG. 1 is a block diagram which shows a main configuration of an optical pulse tester according to an embodiment of the present invention.

FIG. 2 is a diagram which shows a main configuration of a bidirectional module in the embodiment of the present invention.

FIG. 3 is a diagram which shows a modified example of the bidirectional module in the embodiment of the present invention.

### DESCRIPTION OF EMBODIMENTS

The embodiments of the present invention will be now described herein with reference to illustrative preferred embodiments. Those skilled in the art will recognize that many alternative preferred embodiments can be accomplished using the teaching of the present invention and that the present invention is not limited to the preferred embodiments illustrated herein for explanatory purposes.

An aspect of the present invention is to provide an optical pulse tester capable of performing an optical fiber test in a short period of time without causing a decrease in measurement accuracy.

Hereinafter, an optical pulse tester according to an embodiment of the present invention will be described in detail with reference to drawings. In the following description, an outline of the embodiment of the present invention will be described first, and then details of the embodiment of the present invention will be described.

[Outline]

The embodiment of the present invention enables an optical fiber test to be performed in a short period of time without causing a decrease in measurement accuracy. Specifically, wavelength components of return light obtained from an optical fiber are separated for each wavelength band of optical pulses emitted from each of a plurality of light source elements, and the separated wavelength components are individually received by a plurality of light receiving elements, and thereby a simultaneous multi-wavelength measurement is realized without deteriorating the measurement accuracy.

The OTDR disclosed in Japanese Unexamined Patent Application Publication No. 2013-24814 can perform simultaneous multi-wavelength measurement in which optical pulses of a plurality of wavelengths are incident on an optical fiber to perform simultaneous measurement. This OTDR realizes the simultaneous multi-wavelength measurement by causing test light modulated with a random code that is different for each wavelength to be incident on the optical fiber, and performing a correlation operation between a light receiving signal of return light obtained from the optical fiber and the random code described above. However, if such a correlation operation is performed, there is a possibility that a spurious component may occur.

When the spurious component described above occurs, the measurement accuracy of a position of an event such as a connection point of the optical fiber decreases, or the measurement accuracy of a level or the like of a connection loss decreases. In order to prevent a decrease in measurement accuracy, adding a high-speed electric circuit such as a correlator for preventing the decrease in measurement accuracy can be considered, but since such an electric circuit is expensive, a cost of the optical pulse tester will increase significantly.

In the embodiment of the present invention, the optical pulses emitted from the plurality of light source elements that emit optical pulses of different wavelength bands are spatially combined by wavelength to be incident on the optical fiber. Then, the return light from the optical fiber is spatially separated by wavelength to be incident on a plurality of light receiving elements provided to correspond to the plurality of light source elements. As a result, since the wavelength components of the return light separated for each wavelength band of the optical pulses emitted from each of the plurality of light source elements are individually received by the plurality of light receiving elements, it is possible to perform an optical fiber test in a short period of time without causing a decrease in measurement accuracy.

[Detail]

<Optical Pulse Tester>

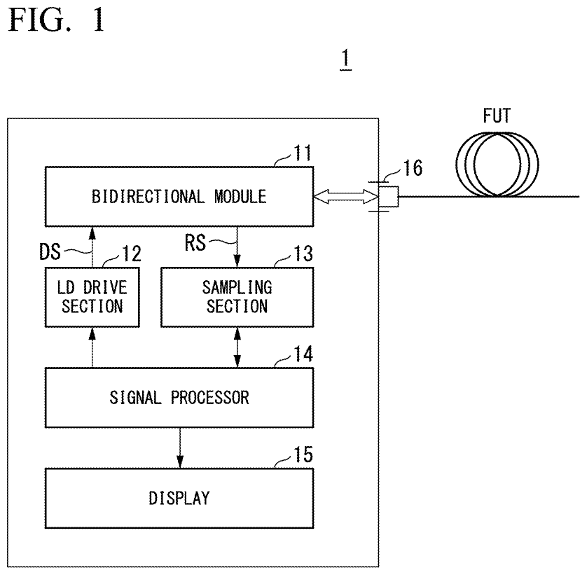

FIG. 1 is a block diagram which shows a main configuration of an optical pulse tester according to an embodiment of the present invention. As shown in FIG. 1, an optical pulse tester 1 of the present embodiment includes a bidirectional module 11, an LD drive section 12, a sampling section 13, a signal processor 14, a display 15, and a connector 16. Such an optical pulse tester 1 tests or measures characteristics of an optical fiber FUT on the basis of return light obtained by causing an optical pulse to be incident on the optical fiber FUT. The optical pulse tester 1 is also called an OTDR.

The bidirectional module 11 outputs an optical pulse (laser light) to be incident on the optical fiber FUT on the basis of a drive signal DS output from the LD drive section 12, and outputs a light receiving signal RS by receiving the return light obtained from the optical fiber FUT. Details of the bidirectional module 11 will be described below.

The LD drive section 12 outputs a drive signal DS that drives the bidirectional module 11 under control of the signal processor 14. That is, the LD drive section 12 outputs a drive signal DS for outputting the optical pulse to be incident on the optical fiber FUT from the bidirectional module 11. The sampling section 13 samples the light receiving signal RS output from the bidirectional module 11 under the control of the signal processor 14.

The signal processor 14 controls the LD drive section 12 and the sampling section 13, and performs an operation required to obtain characteristics of the optical fiber FUT using a signal sampled by the sampling section 13. The display 15 includes, for example, a display device such as a liquid crystal display device, and displays an operation result or the like of the signal processor 14. The operation result of the signal processor 14 may be output to the outside as, for example, a data file. The connector 16 is for connecting one end of the optical fiber FUT to the optical pulse tester 1.

<Bidirectional Module>

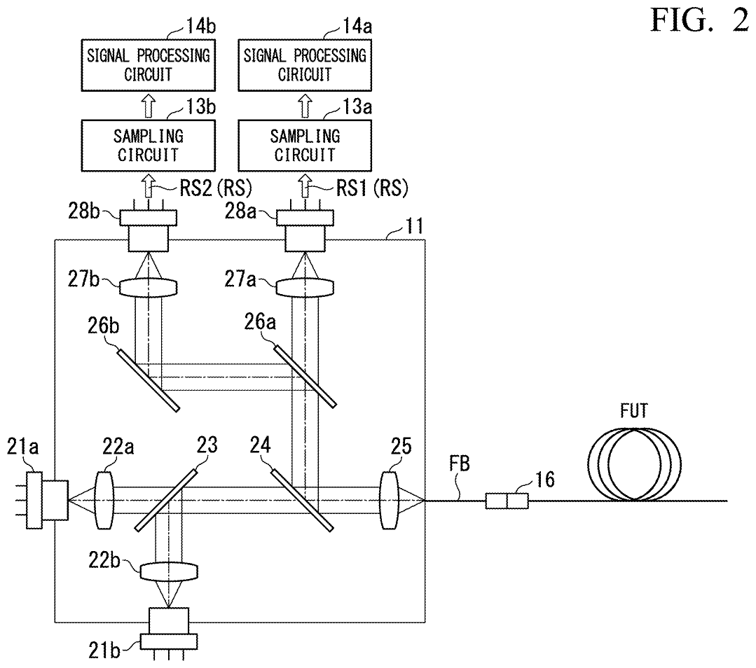

FIG. 2 is a diagram which shows a main configuration of the bidirectional module in the embodiment of the present invention. As shown in FIG. 2, the bidirectional module 11 in the present embodiment includes light source elements 21a and 21b (light source elements), collimating lenses 22a and 22b (first spatial optical system), a wavelength multiplexing element 23 (first spatial optical system), a half mirror 24 (first and second spatial optical systems), a condensing lens 25 (first and second spatial optical systems), wavelength separation elements 26a and 26b (second spatial optical system), condensing lenses 27a and 27b (second spatial optical system), and light receiving elements 28a and 28b.

The light source elements 21a and 21b include, for example, a semiconductor laser, and emit an optical pulse when the drive signal DS output from the LD drive section 12 shown in FIG. 1 is input. The light source element 21a emits an optical pulse of a wavelength λ1 (which may hereinafter be referred to as a “first optical pulse”), and the light source element 21b may emit an optical pulse of a wavelength λ2 (which may hereinafter be referred to as a “second optical pulse”). The wavelength λ1 is in, for example, a 1.31 μm band, and the wavelength λ2 is in, for example, a 1.55 μm band. The wavelength λ2 may be in, for example, a 1.6 μm band.

The collimating lens 22a converts the first optical pulse emitted from the light source element 21a into parallel light, and the collimating lens 22b converts the second optical pulse emitted from the light source element 21b into parallel light. The wavelength multiplexing element 23 spatially combines (combines wavelengths of) the first optical pulse and the second optical pulse converted into parallel light by the collimating lenses 22a and 22b. As the wavelength multiplexing element 23, for example, a dichroic mirror that transmits the first optical pulse and reflects the second optical pulse, or a half mirror can be used.

The half mirror 24 branches incident light at a predetermined divided ratio (for example, 1 to 1). For example, the half mirror 24 transmits 50% of the optical pulses derived from the wavelength multiplexing element 23 and reflects the remaining 50%. In addition, the half mirror 24 reflects 50% of the return light obtained from the optical fiber FUT and transmits the remaining 50%.

The condensing lens 25 couples the optical pulse that has passed through the half mirror 24 to one end of a coupling optical fiber FB. The coupling optical fiber FB has one end connected to the bidirectional module 11 and optically coupled to the condensing lens 25, and the other end connected to the connector 16. That is, one end of the optical fiber FUT is connected to the other end of the coupling optical fiber FB. Moreover, the condensing lens 25 converts the return light obtained from the optical fiber FUT into parallel light and guides it to the half mirror 24.

The wavelength separation element 26a spatially separates the return light reflected by the half mirror 24 (wavelength separation). Specifically, among wavelength components included in the return light, components in the same wavelength band as the wavelength λ1 of the first optical pulse are transmitted, and the other wavelength components (including components in the same wavelength band as the wavelength λ2 of the second optical pulse) are reflected. The wavelength separation element 26b spatially separates the wavelength components reflected by the wavelength separation element 26a (wavelength separation). Specifically, among the wavelength components reflected by the wavelength separation element 26a, the wavelength separation element 26b reflects the components in the same wavelength band as the wavelength λ2 of the second optical pulse, and transmits the other wavelength components.

Here, the wavelength separation element 26b is provided to remove the components in the same wavelength band as the wavelength λ1 of the first optical pulse included in the wavelength components reflected by the wavelength separation element 26a. It is ideal that the wavelength separation element 26a transmit all the components in the same wavelength band as the wavelength λ1 of the first optical pulse and reflect all the components in the same wavelength band as the wavelength λ2 of the second optical pulse. However, in reality, the wavelength components reflected by the wavelength separation element 26a may include the components in the same wavelength band as the wavelength λ1 of the first optical pulse. The wavelength separation element 26b is provided to remove such unnecessary wavelength components. If the unnecessary wavelength components described above can be ignored, a total reflection mirror may be used instead of the wavelength separation element 26b.

A condensing lens 27a couples the wavelength components having passed through the wavelength separation element 26a to a light receiving surface of a light receiving element 28a. A condensing lens 27b couples the components reflected by the wavelength separation element 26b to a light receiving surface of a light receiving element 28b.

The light receiving elements 28a and 28b include, for example, an avalanche photodiode (APD), and photoelectrically convert a wavelength component incident on the light receiving surface, and output a light receiving signal RS according to the wavelength component incident on the light receiving surface. The light receiving element 28a is provided to correspond to the light source element 21a, receives components (the components in the same wavelength band as the wavelength λ1 of the first optical pulse) passing through the wavelength separation element 26a and condensed by the condensing lens 27a, and outputs a light receiving signal RS1. The light receiving element 28b is provided to correspond to the light source element 21b, receives components (the components in the same wavelength band as the wavelength λ2 of the second optical pulse) reflected by the wavelength separation element 26b and condensed by the condensing lens 27b, and outputs a light receiving signal RS2.

Here, the collimating lenses 22a and 22b, the wavelength multiplexing element 23, the half mirror 24, and the condensing lens 25 form a first spatial optical system in which the first and second optical pulses emitted from the light source elements 21a and 21b are spatially combined by wavelength to be incident on the optical fiber FUT. In addition, the condensing lens 25, the half mirror 24, the wavelength separation elements 26a and 26b, and the condensing lenses 27a and 27b form a second spatial optical system in which return light from the optical fiber FUT is spatially separated by wavelength and caused to be incident on the light receiving elements 28a and 28b.

In this second spatial optical system, the return light is spatially separated by wavelength such that the components in the same wavelength band as the wavelength band of the first optical pulse are incident on the light receiving element 28a corresponding to the light source element 21a, and the components in the same wavelength band as the wavelength band of the second optical pulse are incident on the light receiving element 28b corresponding to the light source element 21b. Since the half minor 24 and the condensing lens 25 are shared by the first spatial optical system and the second spatial optical system, it can be said that the first spatial optical system and the second spatial optical system include the half mirror 24 and the condensing lens 25 in common.

As shown in FIG. 2, the light receiving element 28a is provided with the sampling circuit 13a and the signal processing circuit 14a correspondingly, and the light receiving element 28b is provided with the sampling circuit 13b and the signal processing circuit 14b correspondingly. The sampling circuits 13a and 13b are circuits provided in the sampling section 13 shown in FIG. 1, and the signal processing circuits 14a and 14b are circuits provided in the signal processor 14 shown in FIG. 1.

The sampling circuit 13a samples the light receiving signal RS1 output from the corresponding light receiving element 28a. The signal processing circuit 14a uses the signal sampled by the sampling circuit 13a and performs an operation required to obtain the characteristics of the optical fiber FUT. The sampling circuit 13b samples the light receiving signal RS2 output from the corresponding light receiving element 28b. The signal processing circuit 14b uses the signal sampled by the sampling circuit 13b and performs an operation required to obtain the characteristics of the optical fiber FUT.

A reason for providing the sampling circuit 13a and the signal processing circuit 14a corresponding to the light receiving element 28a and the sampling circuit 13b and the signal processing circuit 14b corresponding to the light receiving element 28b is as follows. That is, it is because time required to obtain the characteristics of the optical fiber FUT can be reduced by processing the light receiving signal RS1 output from the light receiving element 28a and the light receiving signal RS2 output from the light receiving element 28b in parallel.

<Operation of Optical Pulse Tester>

When an operation of the optical pulse tester 1 is started, first, the LD drive section 12 is controlled by the signal processor 14 shown in FIG. 1, and a drive signal DS is output from the LD drive section 12. The drive signal DS output from the LD drive section 12 is supplied to the light source elements 21a and 21b of the bidirectional module 11. When the drive signal DS is supplied, the first optical pulse is emitted from the light source element 21a, and the second optical pulse is emitted from the light source element 21b.

The first optical pulse emitted from the light source element 21a is converted into parallel light by the collimating lens 22a, and the second optical pulse emitted from the light source element 21b is converted into parallel light by the collimating lens 22b. The first optical pulse and the second optical pulse converted into parallel light are combined by the wavelength multiplexing element 23. The combined optical pulse is incident on the optical fiber FUT connected to the connector 16 after passing through the half mirror 24, the condensing lens 25, and the coupling optical fiber FB in order. Since the optical pulse propagates through the optical fiber FUT, Rayleigh scattered light and Fresnel reflected light are generated in the optical fiber FUT. These propagate through the optical fiber FUT in an opposite direction (a direction opposite to a propagation direction of the optical pulse) as return light.

The return light output from the optical fiber FUT is reflected by the half mirror 24 and is incident on the wavelength separation element 26a after passing through the coupling optical fiber FB and the condensing lens 25 in order. Among the wavelength components contained in the return light incident on the wavelength separation element 26a, the components in the same wavelength band as the wavelength λ1 of the first optical pulse pass through the wavelength separation element 26a and the components in the same wavelength band as the wavelength λ2 of the second optical pulse are reflected.

The wavelength components (the components in the same wavelength band as the wavelength λ1 of the first optical pulse) having passed through the wavelength separation element 26a are condensed by the condensing lens 27a and then received by the light receiving element 28a. As a result, the light receiving signal RS1 is output from the light receiving element 28a. On the other hand, the wavelength components (the components in the same wavelength band as the wavelength λ2 of the second optical pulse) reflected by the wavelength separation element 26a are reflected by the wavelength separation element 26b, condensed by the condensing lens 27b, and then received by the light receiving element 28b. As a result, the light receiving signal RS2 is output from the light receiving element 28b.

The light receiving signal RS1 output from the light receiving element 28a is used for the operation required to obtain the characteristics of the optical fiber FUT by the signal processing circuit 14a after being sampled by the sampling circuit 13a. In parallel with this, the light receiving signal RS2 output from the light receiving element 28b is used for the operation required to obtain the characteristics of the optical fiber FUT by the signal processing circuit 14b after being sampled by the sampling circuit 13b.

In the signal processing circuits 14a and 14b, for example, an operation for obtaining a distance from the optical pulse tester 1 to a failure point of the optical fiber FUT is performed on the basis of, for example, a time from when the first and second optical pulses are output from the light source elements 21a and 21b, respectively, to when the return light is received by the light receiving elements 28a and 28b. Results of the operations by the signal processing circuits 14a and 14b obtained in such a manner (for example, a transmission loss in the optical fiber FUT, the distance to a point of failure, and the like) are displayed on the display 15.

As described above, in the present embodiment, the first optical pulse emitted from the light source element 21a and the second optical pulse emitted from the light source element 21b are spatially combined by wavelength to be incident on the optical fiber FUT. Then, the return light from the optical fiber FUT is spatially separated by wavelength to be incident on the light receiving elements 28a and 28b. As a result, since wavelength components of the return light separated for each wavelength band of the first and second optical pulses emitted from each of the light source elements 21a and 21b are individually received by the light receiving elements 28a and 28b, respectively, it is possible to perform the optical fiber test in a short period of time without causing a decrease in measurement accuracy.

In addition, in the present embodiment, optical elements constituting the bidirectional module 11 are spatially coupled. As a result, the bidirectional module 11 of the present embodiment can suppress a coupling loss and improve the measurement accuracy as compared with when the optical elements are coupled with an optical fiber. Moreover, the bidirectional module 11 of the present embodiment can achieve space saving and low cost as compared with when the optical elements are coupled with an optical fiber.

### Modified Example

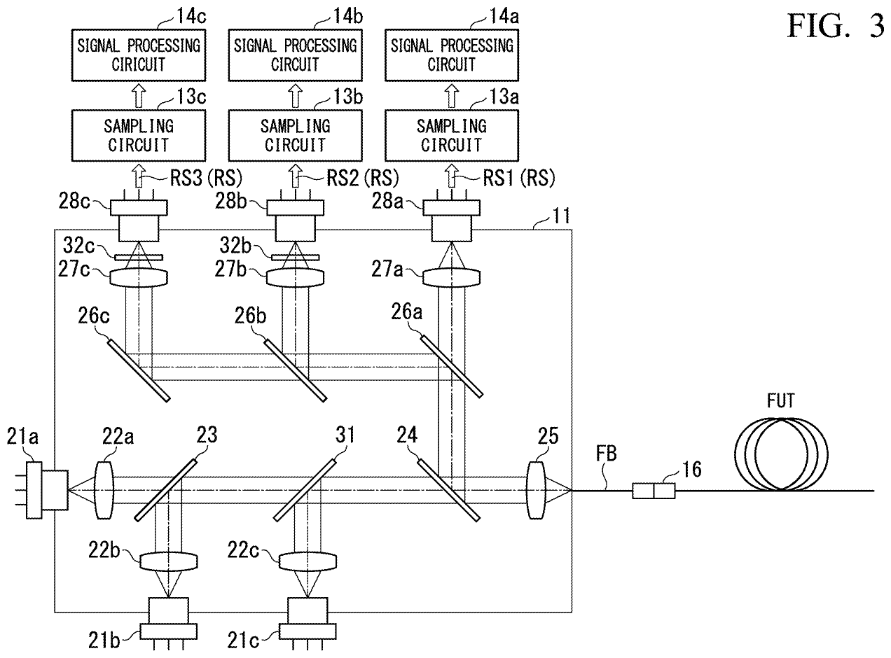

FIG. 3 is a diagram which shows a modified example of the bidirectional module in the embodiment of the present invention. In FIG. 3, the same constituents as those shown in FIG. 2 will be denoted by the same reference numerals. The bidirectional module 11 shown in FIG. 3 additionally includes a light source element 21c, a collimating lens 22c (a first spatial optical system), a wavelength multiplexing element 31 (a first spatial optical system), a wavelength separation element 26c (a second spatial optical system), a condensing lens 27c (a second spatial optical system), a light receiving element 28c, and unnecessary light blocking filters 32b and 32c with respect to the bidirectional module 11 shown in FIG. 2.

The bidirectional module 11 shown in FIG. 2 has realized a two-wavelength simultaneous measurement in which optical pulses of two different wavelengths are incident on the optical fiber FUT to perform a measurement simultaneously. On the other hand, the bidirectional module 11 according to this modified example realizes a three-wavelength simultaneous measurement in which optical pulses of three different wavelengths are incident on the optical fiber FUT to perform a measurement simultaneously.

Similarly to the light source elements 21a and 21b shown in FIG. 2, the light source element 21c includes, for example, a semiconductor laser, and emits an optical pulse when the drive signal DS output from the LD drive section 12 shown in FIG. 1 is input. The light source element 21c emits an optical pulse of a wavelength λ3 (which may hereinafter be referred to as a “third optical pulse”). The wavelength λ3 is, for example, a 1.6 μm band.

The collimating lens 22c is the same as the collimating lenses 22a and 22b, and the wavelength multiplexing element 31 is the same as the wavelength multiplexing element 23. The wavelength separation element 26c spatially separates the wavelength components having passed through the wavelength separation element 26b (wavelength separation). Specifically, among the wavelength components having passed through the wavelength separation element 26b, the wavelength separation element 26c reflects components in the same wavelength band as the wavelength λ3 of the third optical pulse, and transmits the other wavelength components.

Here, the wavelength separation element 26c is provided to remove the components in the same wavelength band as the wavelength λ1 of the first optical pulse and the components in the same wavelength band as the wavelength λ2 of the second optical pulse contained in the wavelength components having passed through the wavelength separation element 26b. There is the same reason as the wavelength separation element 26b shown in FIG. 2. When it is not necessary to remove the wavelength components, a total reflection mirror may be used instead of the wavelength separation element 26c.

The condensing lens 27c is the same as the condensing lenses 27a and 27b. The light receiving element 28c is the same as the light receiving elements 28a and 28b. The light receiving element 28c is provided to correspond to the light source element 21c, receives components reflected by the wavelength separation element 26c and condensed by the condensing lens 27c (the components in the same wavelength band as the wavelength λ3 of the third optical pulse), and outputs a light receiving signal RS3.

The unnecessary light blocking filter 32b is a filter that is disposed between the condensing lens 27b and the light receiving element 28b, and blocks unnecessary light (for example, light other than light in the same wavelength band as the wavelength λ2 of the second optical pulse). The unnecessary light blocking filter 32c is a filter that is disposed between the condensing lens 27c and the light receiving element 28c, and blocks unnecessary light (for example, light other than light in the same wavelength band as the wavelength λ3 of the third optical pulse).

Here, in the example shown in FIG. 3, an unnecessary light blocking filter is not disposed between the condensing lens 27a and the light receiving element 28a. This is because the wavelength separation element 26a has transmission characteristics that do not transmit (or hardly transmit) components other than the components in the same wavelength band as the wavelength λ1 of the first optical pulse. According to the transmission characteristics of the wavelength separation element 26a, an unnecessary light blocking filter may be disposed between the condensing lens 27a and the light receiving element 28a.

Here, the collimating lenses 22a, 22b, and 22c, the wavelength multiplexing element 23, the wavelength multiplexing element 31, the half mirror 24, and the condensing lens 25 form the first spatial optical system in which the first, second, third optical pulses emitted from the light source elements 21a, 21b, and 21c are spatially combined by wavelength to be incident on the optical fiber FUT. In addition, the condensing lens 25, the half mirror 24, the wavelength separation elements 26a, 26b, and 26c, the condensing lenses 27a, 27b, and 27c, and the unnecessary light blocking filters 32b and 32c form the second spatial optical system in which the return light from the optical fiber FUT is spatially separated by wavelength to be incident on the light receiving elements 28a, 28b, and 28c.

In this second spatial optical system, the return light is spatially separated by wavelength such that the components in the same wavelength band as the wavelength band of the first optical pulse is incident on the light receiving element 28a corresponding to the light source element 21a, the components in the same wavelength band as the wavelength band of the second optical pulse is incident on the light receiving element 28b corresponding to the light source element 21b, and the components in the same wavelength band as the wavelength band of the third optical pulse is incident on the light receiving element 28c corresponding to the light source element 21c. Since the half mirror 24 and the condensing lens 25 are shared by the first spatial optical system and the second spatial optical system, it can be said that the first spatial optical system and the second spatial optical system include the half mirror 24 and the condensing lens 25 in common.

As shown in FIG. 3, the light receiving element 28c is provided with a sampling circuit 13c and a signal processing circuit 14c correspondingly. The sampling circuit 13c is a circuit provided in the sampling section 13 shown in FIG. 1 like the sampling circuits 13a and 13b, and the signal processing circuit 14c is a circuit provided in the signal processor 14 shown in FIG. 1 like the signal processing circuits 14a and 14b.

The sampling circuit 13c samples the light receiving signal RS3 output from the corresponding light receiving element 28c. The signal processing circuit 14c uses the signal sampled by the sampling circuit 13c to perform an operation required to obtain the characteristics of the optical fiber FUT. By providing the sampling circuit 13c and the signal processing circuit 14c corresponding to the light receiving element 28c, it is possible to process the light receiving signal RS1 output from the light receiving element 28a, the light receiving signal RS2 output from the light receiving element 28b, and the light receiving signal RS3 output from the light receiving element 28c in parallel. As a result, the time required to obtain the characteristics of the optical fiber FUT can be reduced.

The bidirectional module 11 according to this modified example and the bidirectional module 11 shown in FIG. 2 are different in that the bidirectional module 11 according to this modified example realizes three-wavelength simultaneous measurement, and the bidirectional module 11 shown in FIG. 2 realizes two-wavelength simultaneous measurement. For this reason, an operation of the optical pulse tester including the bidirectional module 11 according to this modified example is basically the same as an operation of the optical pulse tester 1 including the bidirectional module 11 shown in FIG. 2, so that a detailed description of the operation will be omitted.

As described above, in this modified example, the first optical pulse emitted from the light source element 21a, the second optical pulse emitted from the light source element 21b, and the third optical pulse emitted from the light source element 21c are spatially combined by wavelength and are incident on the optical fiber FUT. Then, the return light from the optical fiber FUT is spatially separated by wavelength to be incident on the light receiving elements 28a, 28b, and 28c. As a result, since wavelength components of the return light separated for each wavelength band of the first, second, and third optical pulses emitted from each of the light source elements 21a, 21b, and 21c are individually received by the light receiving elements 28a, 28b, and 28c, respectively, it is possible to perform an optical fiber test in a short period of time without causing a decrease in measurement accuracy.

In addition, also in this modified example, the optical elements constituting the bidirectional module 11 are spatially coupled. As a result, the bidirectional module 11 of this modified example can also suppress the coupling loss, improve the measurement accuracy, and achieve space saving and low cost as compared with when the optical elements are coupled with an optical fiber.

Although the optical pulse tester according to the embodiment of the present invention has been described above, the present invention is not limited to the embodiment described above, and can be freely changed within the scope of the present invention. For example, the optical pulse tester according to the embodiment described above is capable of the two-wavelength simultaneous measurement, and the optical pulse tester according to the modified example described above is capable of the three-wavelength simultaneous measurement, but a simultaneous measurement may be possible with four wavelengths or more.

When it is assumed that N (N is an integer greater than or equal to two) is the number of wavelengths, the optical pulse tester that performs a simultaneous measurement with N wavelengths includes N light source elements and N light receiving elements. In addition, this optical pulse test device includes (N-1) wavelength combining filters in the first spatial optical system and at least (N-1) wavelength separation elements in the second spatial optical system.

In addition, in the optical pulse tester according to the modified example described above, an example of separating the return light from the optical fiber FUT in order from a short wavelength side to a long wavelength side has been described. That is, an example of separating it in order of the components in the same wavelength band as the wavelength λ1 (for example, the 1.31 μm band) of the first optical pulse, the components in the same wavelength band as the wavelength λ2 (for example, the 1.55 μm band) of the second optical pulse, and the components in the same wave length band as the wavelength λ3 (for example, the 1.6 μm band) of the third optical pulse has been described.

However, the return light from the optical fiber FUT may be separated in order from the long wavelength side to the short wavelength side. That is, the return light may also be separated in order of the components in the same wavelength band as the wavelength λ3 (for example, the 1.6 μm band) of the third optical pulse, the components in the same wavelength band as the wavelength λ2 (for example, the 1.55 μm band) of the second optical pulse, and the components in the same wavelength band as the wavelength λ1 (for example, the 1.31 μm band) of the first optical pulse.

Moreover, the optical pulse tester according to the embodiment and the modified example described above has a configuration in which the optical pulses having passed through the half mirror 24 are caused to be incident on the optical fiber FUT and the return light from the optical fiber FUT is reflected by the half mirror 24. However, it also has a configuration in which the optical pulses reflected by the half mirror 24 are caused to be incident on the optical fiber FUT and the return light from the optical fiber FUT is transmitted by the half mirror 24.

### Example of Use

Finally, an example of using the optical pulse tester described above will be described. In the following description, “checking of bending,” “multi-wavelength real-time measurement,” and “checking of a connection condition of an optical fiber to be measured” will be described in order.

<Checking of Bending>

An optical signal propagating through a core of the optical fiber may leak from the core to the outside (clad) when the optical fiber is bent. Since such an optical signal leaking from the core to the outside becomes a loss, power of the optical signal propagating through the core of the optical fiber decreases. Here, as for the optical signal propagating through the core of the optical fiber, an optical signal having a long wavelength is more likely to go out from the core to the outside (clad) than an optical signal having a short wavelength.

The OTDR can detect a position in which the power of the optical signal propagating through the core of the optical fiber changes. For this reason, the optical signal having a short wavelength (for example, 1.31 μm) that is insensitive to bending of the optical fiber and the optical signal having a long wavelength (for example, 1.55 μm or 1.6 μm) that is sensitive to the bending of the optical fiber are simultaneously measured and results of the measurement are compared, and thereby it is possible to check a position in which the bending of the optical fiber is occurring in a short period of time.

In an access network service of the optical fiber system, there is a closure that changes a multi-core cable wired from a base station into a single core cable or stores a distributor or the like called a splitter. In a laying operation of an optical fiber, when an optical fiber is stored in a closure, if it is stored by being bent more than specified or stored by being sandwiched, it may cause a communication failure, or deterioration or breakage of the optical fiber. If the optical pulse tester described above is used, the bending can be detected in a short period of time during the operation described above, so that it is possible to prevent the operation failure described above from occurring.

<Multi-Wavelength Real-Time Measurement>

The OTDR has a function called real-time measurement in which a measurement is performed by reducing a time/the number of times for averaging processing. The main uses of this function are simple checking of a connection status of a connected optical fiber and pre-measurement for deriving an optimum measurement condition. Since a multi-wavelength simultaneous real-time measurement can be realized by using the optical pulse tester described above, a real-time measurement for a measurement condition that is repeatedly performed for each wavelength in the conventional configuration can be simultaneously performed.

Examples in which a measurement condition varies with each wavelength include cases in which the power (pulse width or the like) of measurement light within a measurable range (a DR dynamic range) and the number of times (time) for averaging processing are changed because a loss rate (dB/km) of the optical fiber varies. In addition, there is a case in which, since a refractive index of the optical fiber varies, a group refraction index (10R: Index Of Refraction) for adjusting a connection point and a far end position of a total length changes, or the like. A prior change of the group refractive index can be an automatic correction function of an END point position.

<Checking of Connection Condition of Optical Fiber to be Measured>

In a function of checking a connection with the OTDR before a start of a measurement, a connection condition can be checked by a wavelength to be measured at one time. At a connection point of an optical connector, the connection loss and reflection may vary depending on a wavelength. For example, 1.31 μm may be “OK” (small reflection), but 1.55 μm may be “NG” (large reflection). By using the optical pulse tester described above, such checking can be performed before the start of a measurement.

[Supplementary Note]

An optical pulse tester according to one aspect of the present invention is an optical pulse tester (1) for testing characteristics of an optical fiber (FUT) on the basis of return light obtained by causing an optical pulse to be incident on the optical fiber, the optical pulse tester may include a plurality of light source elements (21a to 21c) configured to emit optical pulses of different wavelength bands, a plurality of light receiving elements (28a to 28c) provided to correspond to the plurality of light source elements, a first spatial optical system (22a to 22c, 23, 24, 25, 31) in which the optical pulses emitted from the plurality of light source elements are spatially combined by wavelength to be incident on the optical fiber, and a second spatial optical system (24, 25, 26a to 26c, 27a to 27c) in which the return light from the optical fiber is spatially separated by wavelength to be incident on the plurality of light receiving elements.

In addition, in the optical pulse tester according to the aspect of the present invention, the second spatial optical system is configured to spatially separate the return light from the optical fiber by wavelength such that components in the same wavelength band as a wavelength band of the optical pulse emitted from one of the plurality of light source elements, among wavelength components contained in the return light from the optical fiber, are incident on a light receiving element corresponding to the one of the plurality of light source elements.

In addition, in the optical pulse tester according to the aspect of the present invention, N (N is an integer greater than or equal to two) of the light source elements and N of the light receiving elements are provided, the first spatial optical system may include (N-1) of wavelength multiplexing elements, and the second spatial optical system may include at least (N-1) of wavelength separation elements.

In addition, the optical pulse tester according to the aspect of the present invention may further include an unnecessary light blocking filter (32b, 32c) that is provided in at least one of the plurality of light receiving elements, and configured to block unnecessary light in a wavelength band different from a wavelength band of the optical pulse emitted from a light source element corresponding to the at least one of the plurality of light receiving elements.

In addition, in the optical pulse tester according to the aspect of the present invention, the first spatial optical system and the second spatial optical system may include comprises in common a half mirror (24) configured to transmit or reflect the optical pulse combined by wavelength by the first spatial optical system, and configured to reflect or transmit the return light from the optical fiber, and a condensing lens (25) that is provided between the half mirror and one end of the optical fiber.

In addition, the optical pulse tester according to the aspect of the present invention may further include a plurality of signal processing circuits (14a to 14c) that are provided to correspond to the plurality of light receiving elements, and configured to process light receiving signals output from the light receiving elements corresponding to the signal processing circuits respectively.

In addition, in the optical pulse tester according to the aspect of the present invention, the first spatial optical system may further include a drive section configured to output a drive signal, the plurality of light source elements is configured to emit the optical pulses in accordance with the drive signal output from the drive section, and the wavelength multiplexing elements are configured to spatially combine the optical pulses emitted from the plurality of light source elements by wavelength.

In addition, in the optical pulse tester according to the aspect of the present invention, the plurality of signal processing circuits is configured to process the light receiving signals output from the plurality of light receiving elements in parallel.

In addition, the optical pulse tester according to the aspect of the present invention may further include a display (15) configured to display an operation result of the plurality of signal processing circuits.

In addition, in the optical pulse tester according to the aspect of the present invention, the display is configured to display a transmission loss in the optical fiber and a distance to a point of failure in the optical fiber.

According to the present invention, there is a special effect that an optical fiber test can be performed in a short period of time without causing a decrease in measurement accuracy.

As used herein, the following directional terms “front, back, above, downward, right, left, vertical, horizontal, below, transverse, row and column” as well as any other similar directional terms refer to those instructions of a device equipped with the present invention. Accordingly, these terms, as utilized to describe the present invention should be interpreted relative to a device equipped with the present invention.

The term “configured” is used to describe a component, unit or part of a device includes hardware and/or software that is constructed and/or programmed to carry out the desired function.

Moreover, terms that are expressed as “means-plus function” in the claims should include any structure that can be utilized to carry out the function of that part of the present invention.

The term “unit” is used to describe a component, unit or part of a hardware and/or software that is constructed and/or programmed to carry out the desired function. Typical examples of the hardware may include, but are not limited to, a device and a circuit.

While preferred embodiments of the present invention have been described and illustrated above, it should be understood that these are examples of the present invention and are not to be considered as limiting. Additions, omissions, substitutions, and other modifications can be made without departing from the scope of the present invention. Accordingly, the present invention is not to be considered as being limited by the foregoing description, and is only limited by the scope of the claims.

What is claimed is:

1. An optical pulse tester for testing characteristics of an optical fiber on the basis of return light obtained by causing an optical pulse to be incident on the optical fiber, the optical pulse tester comprising:
a plurality of light source elements configured to emit optical pulses of different wavelength bands;
a plurality of light receiving elements provided to correspond to the plurality of light source elements;
a first spatial optical system in which the optical pulses emitted from the plurality of light source elements are spatially combined by wavelength to be incident on the optical fiber; and
a second spatial optical system in which the return light from the optical fiber is spatially separated by wavelength to be incident on the plurality of light receiving elements.

2. The optical pulse tester according to claim 1,
wherein the second spatial optical system is configured to spatially separate the return light from the optical fiber by wavelength such that components in the same wavelength band as a wavelength band of the optical pulse emitted from one of the plurality of light source elements, among wavelength components contained in the return light from the optical fiber, are incident on a light receiving element corresponding to the one of the plurality of light source elements.

3. The optical pulse tester according to claim 1,
wherein N (N is an integer greater than or equal to two) of the light source elements and N of the light receiving elements are provided,
wherein the first spatial optical system comprises (N-1) of wavelength multiplexing elements, and
wherein the second spatial optical system comprises at least (N-1) of wavelength separation elements.

4. The optical pulse tester according to claim 1, further comprising:
an unnecessary light blocking filter that is provided in at least one of the plurality of light receiving elements, and configured to block unnecessary light in a wavelength band different from a wavelength band of the optical pulse emitted from a light source element corresponding to the at least one of the plurality of light receiving elements.

5. The optical pulse tester according to claim 1,
wherein the first spatial optical system and the second spatial optical system comprises in common:
a half mirror configured to transmit or reflect the optical pulse combined by wavelength by the first spatial optical system, and configured to reflect or transmit the return light from the optical fiber; and
a condensing lens that is provided between the half mirror and one end of the optical fiber.

6. The optical pulse tester according to claim 1, further comprising:
a plurality of signal processing circuits that are provided to correspond to the plurality of light receiving elements, and configured to process light receiving signals output from the light receiving elements corresponding to the signal processing circuits respectively.

7. The optical pulse tester according to claim 3,
wherein the first spatial optical system further comprises a drive section configured to output a drive signal,
wherein the plurality of light source elements is configured to emit the optical pulses in accordance with the drive signal output from the drive section, and
wherein the wavelength multiplexing elements are configured to spatially combine the optical pulses emitted from the plurality of light source elements by wavelength.

8. The optical pulse tester according to claim 6,
wherein the plurality of signal processing circuits is configured to process the light receiving signals output from the plurality of light receiving elements in parallel.

9. The optical pulse tester according to claim 6, further comprising:
a display configured to display an operation result of the plurality of signal processing circuits.

10. The optical pulse tester according to claim 9,
wherein the display is configured to display a transmission loss in the optical fiber and a distance to a point of failure in the optical fiber.
